(19) United States
(12) Patent Application Publication
(10) Pub. No.: US 2023/0082948 A1
(43) Pub. Date: Mar. 16, 2023

(54) ELECTRONIC SENSOR FOR MONITORING AN HVAC SYSTEM

(71) Applicant: LOSMA S.P.A., Curno (IT)

(72) Inventors: Lorenzo VIGNA GRAP, Lanzo Torinese (IT); Francesco CASTELLETTI, Bergamo (IT)

(73) Assignee: LOSMA S.P.A., Curno (IT)

(21) Appl. No.: 17/603,482

(22) PCT Filed: Jan. 10, 2020
(86) PCT No.: PCT/IB2020/050177

§ 371 Date: Oct. 13, 2021

(30) Foreign Application Priority Data
Apr. 18, 2019 (IT) 102019000006026

(51) Int. Cl. F24F 11/39; B01D 46/00; B01D 46/44

(52) U.S. Cl. CPC F24F 11/39; B01D 46/0086; B01D 46/446; F24F 2110/40

(57) ABSTRACT

An electronic sensor for monitoring aeraulic systems, comprising at least one pressure detector adapted to acquire continuously a differential pressure in a specific point of the system; elements for continuous verification of a trend curve related to the differential pressure variation being provided in order to generate an alarm condition when an inversion of the trend curve is identified, using predefined specific percentage values as limits.

The present invention relates to an electronic sensor for monitoring an aeraulic system. More particularly, the invention relates to an electronic sensor for acquiring and processing differential pressure in industrial systems and for generating and assigning operation computed on the basis of a specific application.

As is known, in industrial system in which there is an aeraulic system in input, a filtering means, an industrial extractor and a further filtering means, it is important to be able to have immediate feedback of the operation of the system, in particular of the conditions of the industrial extractor.

An aeraulic system is a set of apparatuses, devices, accessories required to provide a desired air quality in the preset conditions.

The treatment of the air must therefore be monitored carefully to ensure an adequate quality thereof. Sensors are normally provided which acquire operating parameters of the system and report any anomalies externally to the operator.

The aim of the present invention is to provide an electronic sensor for monitoring aeraulic systems that allows to monitor the conditions and the operation of a system constituted by an aeraulic system, an industrial extractor and a filtering means.

Within this aim, an object of the present invention is to provide an electronic sensor for monitoring an aeraulic system that allows to provide both visible and electrical signals and provision for integration with communication modules with standard protocols.

Another object of the present invention is to provide an electronic sensor for monitoring aeraulic systems that is capable of providing an alarm condition when the preset parameters are exceeded.

Not least object of the present invention is to provide an electronic sensor for monitoring aeraulic systems that is highly reliable, relatively simple to provide and at competitive costs.

This aim, as well as these and other objects which will become better apparent hereinafter, are achieved by an electronic sensor for monitoring aeraulic systems, comprising at least one pressure detector adapted to acquire continuously a differential pressure in a specific point of the system;

means for continuous verification of a trend curve related to the differential pressure variation being provided in order to generate an alarm condition when an inversion of the trend curve is identified, using predefined specific percentage values as limits.

Further characteristics and advantages of the invention will become better apparent from the description of a preferred but not exclusive embodiment of the sensor according to the invention, illustrated by way of non-limiting example in the accompanying drawings, wherein:

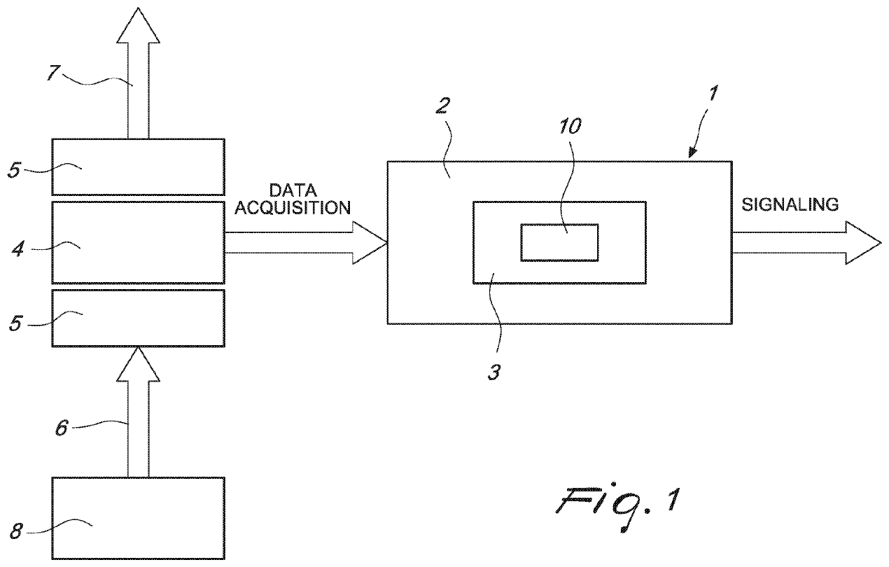

FIG. 1 is a schematic view of an aeraulic system with a sensor according to the invention;

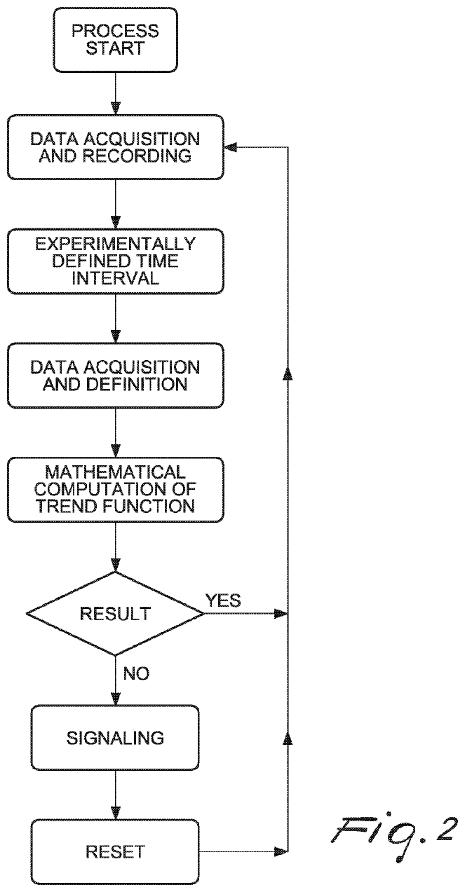

FIG. 2 is a view of the steps of a method for using the sensor according to the invention.

With reference to the figures, the electronic sensor according to the invention, generally designated by the reference numeral 1, comprises a microprocessor sensor 2 provided with an electronic pressure detector 3 so as to acquire the differential pressure, continuously, in a specific point of an aeraulic circuit.

FIG. 1 shows, with the reference numeral 4, an industrial extractor interposed between two filtering means 5, arranged respectively downstream and upstream of an input aeraulic system 6 and an output aeraulic system 7.

The input aeraulic system 6 is arranged downstream of a user system 8.

Furthermore, the sensor 1 is provided with a self-learning function that allows to acquire a given pressure value to be obtained with a voluntary manual operation performed in precise conditions of operation and configuration of the aeraulic system. The acquired value is recorded and used in the sensor management firmware as a reference value for subsequent cases of verification of the operating conditions of the system.

The microprocessor comprises means 10 for the continuous verification of a trend curve related to the differential pressure variation, i.e., it is programmed so as to have a logic with trend inversion control which is organized in a sequence of steps: first of all, pressure values during the operation of the extractor 4 of the system are monitored and recorded, with continuous verification of the trend curve related to the differential pressure variation being considered.

The firmware of the microprocessor of the sensor generates the alarm signals when it identifies the inversion of the trend curve, using as limit specific percentage values that are defined and differentiated according to the types of extractor being considered.

The acquisition logic of an overpressure is divided into two separate functions:
overpressure (1) which covers a settable range of operation from a set point to the limit of the pressure differential sensor. This functionality is managed by a percentage threshold that is fixed with respect to the set point;
overpressure (2) which covers a settable range of operation from the set point to 0 Pa. This functionality is managed by a settable percentage threshold, which compares the pressure detected at the time t(n+2) with the pressure acquired at the time t(n). The time (Δt) that elapses between the pressure recordings can be defined by the user. The pressure at the time t(n+1) is compared with the pressure acquired at the time t(n) and if a trend inversion occurs the function returns the alarm. At each instant after t(n), after the time At, the acquired pressure is saved and becomes the new reference point for the subsequent comparison, keeping the set percentage threshold as control to give the alarm.

The following chart plots an extractor curve as the system condition varies and clarifies the two different anomalies in case of overpressure explained above.

The sensor is therefore used in a system of the aeraulic type which provides for an industrial extractor 4 interposed between two filtering means 5.

The sensor 1 verifies the conditions and the nominal operation of the extractor;

monitors clogging conditions of the filtering means 5, discriminating different clogging levels;

monitors a condition of gradual clogging of the aeraulic system, based on the previously explained mathematical function of “trend inversion” control;

monitors anomaly conditions of the aeraulic system deriving from sudden obstruction of the system;

monitors anomaly conditions of the system deriving from the disengaged extractor or lack of filter installation, lack of duct fitting;

monitors filtering means replacements and times.

The results of the processing performed by the microprocessor are converted into available signals both of the visual type, obtained as groups of high-brightness LEDs of different colors that are activated as a function of the specific signal of its operator, or electrical signals, obtained with interconnection signals that can be provided by the user of the sensor.

Furthermore, the sensor is preset for integration with communication modules with protocols that are publicly available and recognized internationally for the exchange of information with internal and external systems.

The signals that the sensor provides can be of two kinds: dynamic, i.e., they are activated and deactivated automatically in association with the condition identified by the firmware in the system of the microprocessor;

self-maintained, i.e., they are activated when the related condition identified by the firmware of the microprocessor occurs and remain active until the manual reset intervention that the operator can perform.

In practice it has been found that the electronic sensor according to the invention is capable of performing monitoring of an aeraulic system, in particular performing a trend inversion control regarding the differential pressure relation being considered.

The sensor according to the invention is capable of generating alarm signals when it identifies an inversion of the trend curve, using as limit the defined specific percentage values that are differentiated according to the types of extractor being considered.

Trend inversion control allows to maintain a high degree of safety as regards the actual operation of the extractor systems in an aeraulic system.

The method that can be performed by means of the sensor according to the invention provides for the steps that consist in:

monitoring, by means of an electronic sensor 1 provided with an electronic pressure detector 3 adapted to acquire continuously a differential pressure in a given point of the system, pressure values during operation of an extractor 4 of the aeraulic system;

verifying continuously a trend curve related to the acquired differential pressure variation;

generating an alarm signal when an inversion of the trend curve is identified, using predefined percentage values as limits.

The sensor thus conceived is susceptible of numerous modifications and variations, all of which are within the scope of the accompanying claims.

All the details may furthermore be replaced with other technically equivalent elements.

In practice, the materials used, as well as the contingent shapes and dimensions, may be any according to the requirements and the state of the art.

The disclosures in Italian Patent Application no. 102019000006026, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1.-5. (canceled)

6. An electronic sensor for monitoring aeraulic systems, comprising at least one pressure detector adapted to acquire continuously a differential pressure in a specific point of the system;
means for continuous verification of a trend curve related to a differential pressure variation being provided in order to generate an alarm condition when an inversion of a trend curve is identified, using predefined specific percentage values as limits.

7. The sensor according to claim 6, further comprising visual signaling means.

8. The sensor according to claim 7, further comprising electrical signaling means.

9. A method for controlling an aeraulic system, comprising the steps of:
monitoring, by means of an electronic sensor provided with an electronic pressure detector adapted to acquire continuously a differential pressure in a specific point of the aeraulic system, pressure values during operation of an extractor of said aeraulic system;
continuously verifying a trend curve related to an acquired differential pressure variation;
generating an alarm signal when an inversion of said trend curve is identified, using predefined percentage values as limits.

10. The method according to claim 9, wherein said differential pressure is a pressure variation identified in two distinct points of the aeraulic system.
